(19) United States
(12) Patent Application Publication
(10) Pub. No.: US 2015/0128811 A1
(43) Pub. Date: May 14, 2015

(54) Nutrient Infuser For Drinking Water

(71) Applicant: Solves Innovative Technology Pte Ltd, Singapore (SG)

(72) Inventors: Dhanabalan Durairajasivam, Tamil Nadu (IN); Teng Hwee Koh, Singapore (SG)

(73) Assignee: Solves Innovative Technology Pte Ltd, Singapore (SG)

(21) Appl. No.: 14/395,066

(22) PCT Filed: Apr. 17, 2013
(86) PCT No.: PCT/SG2013/000151

§ 371 Date: Oct. 17, 2014

(30) Foreign Application Priority Data
Apr. 18, 2012 (SG) 201202814-8

(51) Int. Cl. C02F 1/68; C02F 1/00

(52) U.S. Cl. CPC C02F 1/686; C02F 1/008; C02F 2307/10; C02F 2209/40; C02F 2209/06; C02F 2209/10; C02F 2209/05; C02F 2307/06
USPC 99/283

(57) ABSTRACT

The present invention provides a nutrient infuser removably attached to a drinking water source to remineralize drinking water. The nutrient infuser comprises a pipe provided for the drinking water to flow therethrough, wherein flow rate of the drinking water is measured by a flow meter. The flow meter converts flow rate into electronic signals which will be received by a controller. The controller totalizes the electronic signals and uses it to further generate another electronic signal to activate an injector to operate accordingly. Upon activation, the injector draws a predetermined amount of consumable substances from a canister and injects the same to the drinking water flowing through the pipe, remineralizing the drinking water, making it healthier for consumption. The predetermined amount of consumable substances injected to the drinking water corresponds to the flow rate of the drinking water. The consumable substances may comprise essential minerals, vitamins or flavoring.

### FIELD OF THE INVENTION

The present invention relates to a device that automatically infuses nutrients, minerals etc. proportionally into water as the water flows through the device.

### BACKGROUND

Water has always played a vital role for survival in most living organisms. Similarly, it is essentially important to provide safe drinking water to people and other living organisms. Safe drinking water may be water that is pure enough to consume or to be used with low risk of harm.

Access to safe drinking water has vastly improved over the last few decades in most part of the world. Water that is of safe drinking water standard may be supplied to households, commerce, various industries, etc. in most developed countries. However, there is still a large population of people who lacks access to adequate sanitation or do not have proper water sources such as well-maintained water pipes, water storage tank, taps, etc., thereby the drinking water is prone to contamination. For example, drinking water may be contaminated, when it has to travel long distances of pipes and may be stored for a long period of time in a poorly maintained water tank. Contaminated drinking water thus may be provided, and yet it is unbeknownst to the large population of people.

Contaminants found in drinking water, if consumed, may be hazardous to a person's health especially over a long period of time. It is usually required that water is treated before being supplied to the households etc. Water may be treated through processes such as desalination, sedimentation, reverse osmosis, etc. These processes may be combined together, depending on the type of water source.

For example, reverse osmosis (RO) is a membrane-technology filtration method that may remove particles, impurities, contaminants, etc. from water. RO may also be combined together with desalination to produce “pure” drinking water by removing salt particles and the other impurities from the water. However, such processes are usually expensive and typically used for large-scale water treatment purposes.

Additionally, recent studies shows that prolong consumption of “pure” drinking water may alter a person's body minerals and water metabolism. “Pure” drinking water lacks nutrients and minerals such as Calcium, Magnesium, Sodium, Potassium, etc. These nutrients and minerals are beneficial to the human body. For example, calcium may be important in bone health. Potassium is important for a variety of biochemical effects. Sodium is an important extra-cellular electrolyte.

In a World Health Organization (WHO) paper, titled “Health risks from Drinking Demineralised Water”, it addressed possible health consequences of low mineral content water consumption. The health consequences that were addressed includes direct effects on the intestinal mucous membrane, metabolism, and mineral homeostasis or other body functions; zero calcium and magnesium intake; low intake of other essential elements and microelements; possible increased dietary intake of toxic metals leached from water pipe; and possible bacterial regrowth.

To address the problems of low essential nutrients and mineral in water for consumption, a large-scale process called re-mineralization is adopted. During re-mineralization, essential nutrients and minerals are dissolved to the purified water. Water purification process combined with re-mineralization thus produces a pure drinking water that is free of contaminants, yet is sufficiently contained with essential nutrients and minerals.

### SUMMARY

In one aspect of the present invention, there is provided a nutrient infuser removably attached to a small-scale drinking water source supplying drinking water. The nutrient infuser comprising a pipe provided for the drinking water to flow through the nutrient infuser; a canister containing consumable substances; a flow meter that measures the flow rate of the drinking water flowing through the pipe, the flow rate being converted into electronic signals; a controller adapted to receive electronic signals from the flow meter and generating another electronic signal to be transmitted to an injector, automatically activating the injector to draw and inject a desired amount of consumable substances into the flowing drinking water in the pipe; wherein the nutrient infuser automatically adds consumable substances from the canister into the drinking water flowing within the pipe, corresponding to the flow rate of the drinking water. The flow direction of the injected consumable substances follows the flow direction of the drinking water.

In one embodiment of the present invention, the nutrient infuser further comprises an attachable mean that removably attaches the nutrient infuser to the drinking water source.

In another embodiment of the present invention, the flow meter, the pump and the controller are electrically coupled together.

In yet another embodiment, the flow meter is used to measure the flow rate of the drinking water from the drinking water source. The flow meter can be magnetic flow meters, ultrasonic flow meters, turbine flow meters, paddle wheel meters, and the like.

In a further embodiment, the injector is a pump. The pump is selected from the group consisting of a diaphragm pump, a metering pump, and pumps that are responsive to electronic signals.

In yet another embodiment, the consumable substances stored in the canister include nutrients, vitamins, minerals or flavorings. The essential minerals may be selected a mineral selected from the group consisting Calcium, Magnesium, Chloride, Sodium, Fluoride, Potassium, Selenium, Iron, Zinc, Copper, Phosphorus, Iodine, Sulfate, Lithium, and Boron.

In one embodiment of the present invention, the canister is removably attached to the nutrient infuser via a coupler. The canister may further comprise a uni-directional valve for preventing vacuum build-up within the canister

In yet another embodiment of the present invention, the nutrient infuser further comprises a casing to accommodate the pipe, the flow meter and the controller.

In another embodiment of the present invention, the nutrient infuser is operable via various power means. The power means comprises an external battery source. Further, the power means comprises a household power source.

In yet another embodiment, the nutrient infuser is operable via implementation of fluid pressure effects (called venturi effect) to draw the consumable substances from the canister without requiring any power means.

### BRIEF DESCRIPTION OF THE DRAWINGS

This invention will be described by way of non-limiting embodiments of the present invention, with reference to the accompanying drawings, in which:

FIG. 1 illustrates a schematic view of a nutrient infuser as one embodiment of the present invention;

FIG. 2 provides an exemplary illustration of the nutrient infuser that may be integrated with a drinking water source as another embodiment of the present invention;

FIG. 3 provides another exemplary illustration of the nutrient infuser that may be removably attached to the drinking water source via the attachable mean, as another embodiment of the present invention; and

FIG. 4 provides another exemplary illustration of the NI that integrated to a drinking water source as another embodiment of the present invention.

### DETAILED DESCRIPTION

The following descriptions of a number of specific and alternative embodiments are provided to understand the inventive features of the present invention. It shall be apparent to one skilled in the art, however that this invention may be practiced without such specific details. Some of the details may not be described in length so as to not obscure the invention. For ease of reference, common reference numerals will be used throughout the figures when referring to same or similar features common to the figures.

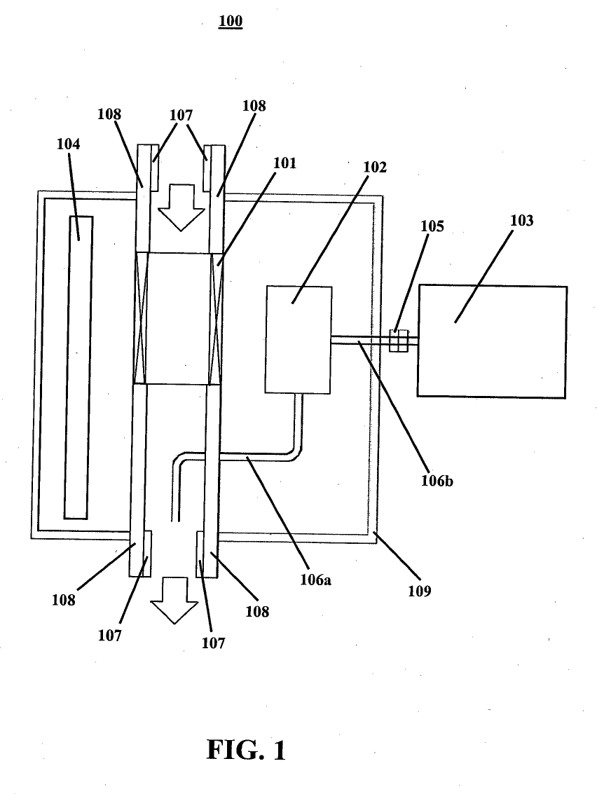

FIG. 1 illustrates a schematic view of a nutrient infuser (NI) 100 as one embodiment of the present invention. The NI 100 is a device capable of automatically adding a plurality of consumable essential substances such as nutrients, minerals, flavorings, etc. proportionally into drinking water flowing from a drinking water source. The NI 100 is suitable for usage in a small-scale drinking water source, such as that used at home or office. The drinking water source may be a faucet, valve, bottled water dispenser, etc.

The NI 100 comprises a flow meter 101, a pump 102, a canister 103, a controller 104, a coupler 105, an attachable mean 107 and a pipe 108. The NI 100 may further include a casing 109 that accommodates the flow meter 101, the pump 102, the controller 104, and the pipe 108. The casing 109 may be made of any material such as plastics, metals, etc.

The pipe 108 is located in the NI 100. The attachable mean 107 may be fixated to inlet and outlet of the pipe 108. The flow meter 101 is located within the upper section of the pipe's 108 sidewalls and is electrically coupled to the controller 104. The controller 104 is externally located along the pipe's 108 sidewalls and is also electrically coupled to the pump 102. The pump 102 is also externally located along the pipe's 108 sidewalls

The above-described location of the pipe, the controller and the pump within the NI are only for illustrative purpose of the present embodiment and are not meant to limit the present invention in any way. The pipe, the controller and the pump of the NI can be configured within the NI in a variety of locations so as to provide same functions and purposes for the NI.

Still referring to FIG. 1, the pump 102 has an outlet 106a and an inlet 106b. The outlet 106a is inserted through the sidewalls of the pipe 108, extending into hollow space within the pipe 108. Meanwhile, the inlet 106b is connected to the canister 103 by the coupler 105. The coupler 105 is a quick-release coupler.

The drinking water may be supplied to the drinking source from a reservoir, a water storage tank or any other known water supply. The drinking water may have been pre-treated at the water supply to eliminate contaminants, adjust pH, etc. Nevertheless, it is still possible that the drinking water source may also include a filter to further eliminate contaminants etc. that may still be present in the drinking water.

In one embodiment of the present invention, the NI 100 may be integrated together with the drinking water source. The NI 100 may also be attached to the drinking water source via the attachable mean 107. The attachable mean 107 may be a pipe thread, a suction connector, or any other known connector that may removably attach the NI 100 with the drinking water source. Once the NI 100 is attached to the drinking water source, the drinking water from the drinking water source may then flow through the hollow space of the pipe 108 in the NI 100.

In yet another embodiment of the present invention, the flow meter 101 is a device that may measure a flow rate, which is the rate of a fluid movement. Flow rate may be measured in a variety of ways. Similarly, there are a wide variety of flow meters 101 available to measure the flow rate of a fluid. The flow meter 101 is adapted in the NI 100 to measure the flow rate of the drinking water in volume per unit time. It is understood to any person skilled in the art that any type of flow meter 101 may be adapted in the NI 100. Some examples include magnetic flow meters, ultrasonic flow meters, turbine flow meters, paddle wheel meters, etc.

As the drinking water flows through the pipe 108, the flow meter 101 measures the flow rate of the drinking water. Further, the flow meter 101 converts the drinking water flow rate into electronic signals and the electronic signals are transmitted to the controller 104. The controller 104 receives the electronic signals from the flow meter 101, processes the signals accordingly and generates another electronic signal to activate the pump 102. Thus, the electronic signals generated to activate the pump correspond to the flow rate of the drinking water through the pipe 108. In another embodiment of the present invention, the pump 102 may be a diaphragm pump, a metering pump, or any type of pump that may be responsive to electronic signals.

In a further embodiment, the pump 102 may be a piezoelectric pump that consumes very little power to operate.

In a further embodiment, the controller 104 may totalize signals regarding the flow rate of the drinking water, so that when a certain volume of drinking water has flown therethrough, the controller 104 accordingly activates the pump.

Upon activation, the pump 102 draws the consumable substances from the canister 103 through the pump inlet 106b and pumps the desired proportion of the consumable substances through the outlet 106a into the drinking water flowing within the hollow space of the pipe 108. The injection direction of the essential substances follows the flow direction of the drinking water within the pipe 108. As such, the consumable substances are accordingly dissolved to the drinking water flowing out of the pipe 108 in the NI 100, producing remineralized drinking water. The drinking water is now sufficiently healthy for consumption. It may be desired that the pump 102 pumps a desired amount of consumable substances into the flowing drinking water, so as to obtain a desired proportion of consumable substances-infused drinking water. Therefore, the amount of consumable substances pumped correlates with the flow rate of the drinking water For example, when it is desired to get 1 ml consumable substances per 100 ml of drinking water, 1 ml of the consumable substances will be pumped into every 100 ml of drinking water, and accordingly 2 ml of the consumable substances will be pumped into 200 ml of drinking water. Further, the pump 102 may be calibrated in accordance with fluid viscosity and electronic signals generated by the controller 104.

In a further embodiment of the present invention, the controller 104 may be a PCB board having several electronic components such as capacitor, resistor, any pluralities of IC chips to provide data and program storage. The controller 104 may also be electrically coupled to a user interface that may be attached externally on the casing 109 of the NI 100. The user interface may be a liquid crystal display (LCD) window having plurality of keypads, a touch-screen device, and the like. In a further embodiment, the user interface can be a separate console unit that is only connected to the NI 100 when necessary.

In a further embodiment, the user interface may also be a separated console unit of which being connected to the NI 100 when necessary.

The user interface allows users to accordingly set the desired proportion of the consumable substances in the drinking water. The input from the user is then communicated to the controller 104, and the controller 104 will, based on the user input and the electronic signals on the water flow rate detected from the flow meter, accordingly generate electronic signals activating the pump to pump the desired amount of consumable substances.

In a further embodiment, the pump 102 may be configured to provide feedback to the controller 104 when the proportion of the consumable substances pumped is not accurate. The controller 104 may also be configured to detect other abnormalities in the NI 100 such as depleting power or consumable substances in the canister 103, etc. The details of the occurring abnormalities may be displayed in the user interface. The user interface may further give out a warning signal such as an alarm, blinking LED etc. to alert abnormalities in the NI 100. Further, the user interface is also able to display data pertaining to the quality of the drinking water, such as the pH, total dissolved solids (TDS), conductivity, etc.

As shown in FIG. 1, the plurality of consumable substances is stored in the canister 103. The consumable substances may be stored in a capsule form or any other coating or shell that may be easily soluble in water. The composition or formula of the various consumable substances in one capsule may be customized accordingly. The concentration of the consumable substances may also be of a variety of concentration, etc. It is preferable that the composition and concentration of the consumable substances is complied with the Recommended Daily Allowance (RDA). The composition of the consumable substances may include essential minerals, such as Calcium, Magnesium, Chloride, Sodium, Fluoride, Potassium, Selenium, Iron, Zinc, Copper, Phosphorus, Iodine, Sulfate, Lithium, and Boron, vitamins, or any other necessary substances.

The composition and concentration of the consumable substances, according to one embodiment of the present invention, are summarized in Table 1 below. With such composition and concentration, it is preferable to infuse 0.1 ml˜0.2 ml of the consumable substances to 200 ml of drinking water.

TABLE 1
Supplement Facts
Serving size: 0.1 ml-0.2 ml per 200 ml water

| Amount Per Serving | | | % DV |
|---|---|---|---|
| Magnesium | 250 | mg | 63% |
| Chloride | 690 | mg | 20% |
| Sodium | 6 | mg | <1% |
| Potassium | 3 | mg | <1% |
| Sulfate | 37 | mg | ** |
| Lithium | 395 | mcg | ** |
| Boron | 370 | mcg | ** |

** Daily Value not established.

In a further embodiment, once the plurality of consumable substances in the canister 103 depletes, the entire canister 103 may be removed from the NI 100 via the coupler 105. A new canister 103 filled with the plurality of consumable substances may then be reattached to the coupler 105. Referring again to FIG. 1, the coupler 105 allows the canister 103 to be easily removed from the NI 100. Likewise, the coupler 105 allows the canister 103 to be easily reattached onto the NI 100. It is preferable that a uni-directional valve is disposed in the canister 103. The uni-directional valve shall allow air to flow into the canister 103, thus preventing vacuum build-up within the canister 103 caused by the operation of the pump 102 drawing the consumable substances from the canister. If vacuum, or negative pressure, is allowed to build up in the canister 103, the pump 102 will fail to function properly that it cannot draw the consumable substances from the canister 103. The uni-directional valve also prevents the consumable substances to flow therethrough. The consumable substances can only be drawn out from the canister by the pump 102.

In another embodiment of the present invention, the NI 100 may be operable via various power means such as an external battery source, household power source, etc.

In the above embodiments, pump is used as means for pumping and injecting consumable substances to the drinking water flowing out from the drinking water source. However, the pump is not the only means that can be used to perform such functions in the NI 100 of the present invention. Any other possible injectors or dispensing means can also be used herein so as to perform similar functions and serve same purpose in the NI 100. The NI 100 may also implement fluid pressure effects such as Venturi effect, etc. to draw the consumable substances from the canister 103 without requiring any power means.

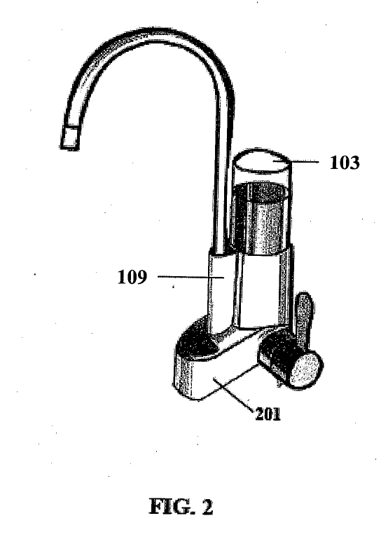

FIG. 2 provides an exemplary illustration of the NI that integrated with a drinking water source 201 as another embodiment of the present invention. The drinking water source may be a faucet, valve, etc. In this embodiment, the housing 109 accommodating the pump, the flow meter, and the controller is integrated to the drinking water source 201. The nutrient canister 103 is removably attached to the housing 109 attached to the drinking water source 201 so that when the consumable substances in the canister 103 depletes, user can promptly replace the empty canister with a new one.

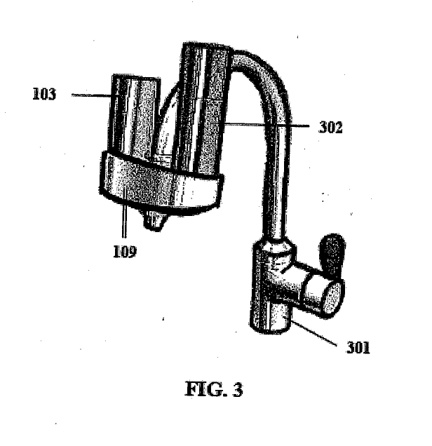

FIG. 3 provides another exemplary illustration of the NI that may be removably attached to another drinking water source 301 via the attachable mean (not shown), as another embodiment of the present invention. In this embodiment, the housing 109 of the NI 100 is removably attached to the outlet of the water source 301, while the nutrient canister 103 is attached to the housing of the NI. A water filter 302 comprising UF filter and activated carbon may also be attached to the housing 109 of the NI for further filtering the drinking water. In another embodiment, another type of water filter may also be used together with the NI of the present invention.

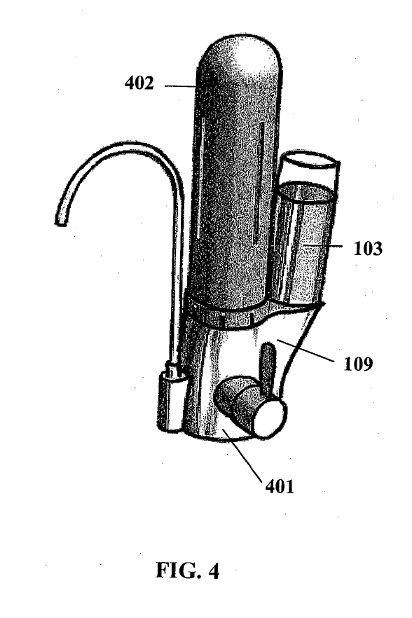

FIG. 4 provides another exemplary illustration of the NI that integrated to another drinking water source 401 as another embodiment of the present invention. This embodiment follows configuration of a counter-top water system. In this embodiment, the housing 109 accommodating the pump, the flow meter, and the controller is integrated to the drinking water source 401. The nutrient canister 103 is removably attached to the housing 109 integrated to the drinking water source 401 so that when the consumable substances in the canister 103 depletes, user can promptly replace the empty canister with a new one. A water filter 402, such as UF filter, reverse-osmosis filtering device and activated carbon is attached to the housing 109 integrated to the drinking water source 401. The water filter 402 further filters the drinking water. Any other type of water filter may also be used herein.

The NI 100 may also be used with other drinking water supply such as water containers, water bottles etc. A water filter may also be attached between the drinking water source and the NI 100, or integrated together with the NI 100, to further filtrate contaminants away from the drinking water flowing through the NI 100.

The above description illustrates various embodiments of the present invention along with examples of how aspects of the present invention may be implemented. While specific embodiments have been described and illustrated it is understood that many changes modifications, variations and combinations thereof could be made to the present invention without departing from the scope of the present invention. The above examples, embodiments, instructions semantics, and drawings should not be deemed to be the only embodiments, and are presented to illustrate the flexibility and advantages of the present invention as defined by the following claims:

1. A nutrient infuser removably attached to a small-scale drinking water source supplying drinking water, the nutrient infuser comprising:
a pipe provided for the drinking water to flow through the nutrient infuser;
a canister containing consumable substances;
a flow meter for measuring the flow rate of the drinking water flowing through the pipe, the flow rate is being converted into electronic signals;
a controller adapted to receive electronic signals from the flow meter and generate another electronic signal to be transmitted to an injector, thereby activating the injector to operate; wherein
the injector has an inlet and an outlet, the inlet of the injector is coupled to the canister and the outlet of the injector is inserted into the pipe, wherein the injector operationally draws a desired amount of consumable substances from the canister through the inlet and injects the consumable substances to the pipe through the outlet as the drinking water flows through the pipe, the amount of the consumable substances drawn and injected corresponding to the flow rate of the drinking water;
whereby the nutrient infuser automatically adds the consumable substances from the canister into the drinking water flowing within the pipe so as to provide remineralized drinking water.

2. The nutrient infuser according to claim 1, further comprising an attachable means for removably attaching the nutrient infuser to the drinking water source.

3. The nutrient infuser according to claim 1, wherein the controller further ensures that the amount of nutrient being injected to the drinking water corresponds to the flow rate of drinking water flowing through the pipe.

4. The nutrient infuser according to claim 1, wherein the flow meter is used to measure the flow rate of the drinking water from the drinking water source.

5. The nutrient infuser according to claim 4, wherein the flow meter is selected from a group consisting of magnetic flow meters, ultrasonic flow meters, turbine flow meters, paddle wheel meters, and the like.

6. The nutrient infuser according to claim 1, wherein the injector is a pump.

7. The nutrient infuser according to claim 6, wherein the pump is selected from the group consisting of a piezoelectric pump, a diaphragm pump, a metering pump, and any pumps that are responsive to electronic signals.

8. The nutrient infuser according to claim 1, wherein the controller may be a PCB board having several electronic components such as capacitor, resistor, any pluralities of IC chips to provide data and program storage.

9. The nutrient infuser according to claim 8, wherein the controller further comprises a user interface for allowing users to accordingly set the desired proportion of the consumable substances in the drinking water and display data pertaining to the quality of the drinking water, such as the pH, total dissolved solids (TDS), conductivity, etc.

10. The nutrient infuser according to claim 8, wherein the controller is configured to detect abnormalities in the nutrient infuser and give out a warning signal to alert the users with regard to the abnormalities.

11. The nutrient infuser according to claim 9, wherein the user interface is a liquid crystal display (LCD) window having plurality of keypads, a touch-screen device, and the like.

12. The nutrient infuser according to claim 9, wherein the user interface is a separatable console unit which only being connected to the nutrient infuser when needed.

13. The nutrient infuser according to claim 1, wherein the injector is configured to provide a feedback to the controller to ensure that the injector works properly.

14. The nutrient infuser according to claim 1, wherein the consumable substances stored in the canister comprise essentials elements selected from a group consisting of nutrients, vitamins, minerals and flavorings.

15. The nutrient infuser according to claim 12, wherein the essential minerals are minerals selected from a group consisting of Calcium, Magnesium, Chloride, Sodium, Fluoride, Potassium, Selenium, Iron, Zinc, Copper, Phosphorus, Iodine, Sulfate, Lithium, and Boron.

16. The nutrient infuser according to claim 1, wherein the canister is removably attached to the nutrient infuser via a coupler.

17. The nutrient infuser according to claim 1, wherein the canister further comprises a uni-directional valve for preventing vacuum build-up within the canister.

18. The nutrient infuser according to claim 1, wherein the desired amount of consumable substances that is pumped into the flowing drinking water is in proportion to the flow rate of the drinking water.

19. The nutrient infuser according to claim 1, further comprising a casing to accommodate the pipe, the flow meter, the controller.

20. The nutrient infuser according to claim 1, wherein the nutrient infuser is operable via various power means.

21. The nutrient infuser according to claim 19, wherein the power means is an external battery source.

22. The nutrient infuser according to claim 19, wherein the power means is a household power source.

23. The nutrient infuser according to claim 1, wherein the nutrient infuser is operable via implementation of fluid pressure effects to draw the consumable substances from the canister without requiring any power means.
